(19) United States
(12) Patent Application Publication
(10) Pub. No.: US 2026/0314686 A1
(43) Pub. Date: Oct. 15, 2026

(54) SEALING MEMBER, ATOMIZER, AND ELECTRONIC ATOMIZATION DEVICE

(71) Applicant: SHENZHEN FIRST UNION TECHNOLOGY CO., LTD., Shenzhen, Guangdong (CN)

(72) Inventors: Baofeng XIE, Shenzhen, Guangdong Province (CN); Yuanhua FENG, Shenzhen, Guangdong Province (CN); Zhongli XU, Shenzhen, Guangdong Province (CN); Yonghai LI, Shenzhen, Guangdong Province (CN)

(73) Assignee: SHENZHEN FIRST UNION TECHNOLOGY CO., LTD., Shenzhen, Guangdong Province (CN)

(21) Appl. No.: 19/117,111

(22) PCT Filed: Oct. 25, 2023
(86) PCT No.: PCT/CN2023/126550

§ 371 Date: Mar. 31, 2025

(30) Foreign Application Priority Data
Oct. 25, 2022 (CN) 202211313860.1
Mar. 27, 2023 (CN) 202320643352.3

(51) Int. Cl. A24F 40/48; A24F 40/10; A24F 40/42; A24F 40/46; H05B 3/03

(52) U.S. Cl. CPC A24F 40/48; A24F 40/10; A24F 40/42; A24F 40/46; H05B 3/03

(57) ABSTRACT

The present application provides a sealing member, an atomizer, and an electronic atomization device. The atomizer comprises: a housing, a liquid storage cavity used for storing a liquid matrix being provided in the housing; an atomization assembly used for atomizing the liquid matrix to generate an aerosol; and a sealing member partially defining the liquid storage cavity, an accommodating cavity and an aerosol transmission channel being provided in the sealing member, the accommodating cavity being used for accommodating the atomization assembly, the aerosol transmission channel being used for transmitting the aerosol generated by atomizing the liquid matrix by the atomization assembly, the sealing member comprising a side wall at least partially surrounding the accommodating cavity and/or the aerosol transmission channel, and the side wall being provided with at least one first opening for communicating the accommodating cavity with the aerosol transmission channel.

### CROSS-REFERENCE TO RELATED APPLICATIONS

This application claims priority to Chinese Patent Application No. 202211313860.1, filed with the China National Intellectual Property Administration on Oct. 25, 2022 and entitled “SEALING MEMBER, ATOMIZER, AND ELECTRONIC ATOMIZATION DEVICE”, and Chinese Patent Application No. 202320643352.3, filed with the China National Intellectual Property Administration on Mar. 27, 2023 and entitled “ATOMIZER AND ELECTRONIC ATOMIZATION DEVICE”, which are incorporated herein by reference in their entireties.

### TECHNICAL FIELD

The present application relates to the field of electronic atomization technologies, and in particular, to a sealing member, an atomizer, and an electronic atomization device.

### BACKGROUND

An electronic atomization device is an electronic product that generates an aerosol by atomizing an e-liquid matrix for a user to inhale, which generally includes two parts: an atomizer and a power supply assembly. The e-liquid matrix is stored inside the atomizer, and an atomization core for atomizing the e-liquid matrix is arranged inside the atomizer. The power supply assembly includes a battery and a circuit board.

### SUMMARY

An aspect of the present application provides an atomizer, including a housing. The housing is provided inside with:
an e-liquid storage cavity, configured to store an e-liquid matrix;
an atomization assembly, configured to atomize the e-liquid matrix to generate an aerosol; and
a sealing member, partially defining the e-liquid storage cavity. An accommodating cavity and an aerosol conveying channel are provided in the sealing member. The accommodating cavity is configured to accommodate the atomization assembly, and the aerosol conveying channel is configured to convey the aerosol generated by atomizing the e-liquid matrix by the atomization assembly.

The sealing member includes a side wall that at least partially surrounds the accommodating cavity and/or the aerosol conveying channel; and the side wall has at least one first opening that communicates the accommodating cavity with the aerosol conveying channel, so that the aerosol generated by the atomization assembly flows into the aerosol conveying channel through the first opening.

In some embodiments, the atomization assembly includes an e-liquid guide element and a heating element bound to the e-liquid guide element. The sealing member defines that a portion of an inner surface of the accommodating cavity is elastically abutted to at least a portion of an outer surface of the e-liquid guide element, to seal the portion of the outer surface of the e-liquid guide element.

In some embodiments, the sealing member further includes an air pressure balance channel communicated with the e-liquid storage cavity, and the air pressure balance channel is configured to provide a path for replenishing air into the e-liquid storage cavity.

Another aspect of one aspect of the present application further provides an electronic atomization device, including a power supply assembly and the foregoing atomizer.

Another aspect of one aspect of the present application further provides a sealing member for an electronic atomization device, including a first end, a second end facing away from the first end, and a body extending from the first end to the second end.

An outer surface of the body close to the first end has a first flange, and an outer surface of the body close to the second end has a second flange.

An accommodating cavity and an aerosol conveying channel are arranged in the sealing member. The accommodating cavity is configured to accommodate an atomization assembly. The aerosol conveying channel is configured to transmit an aerosol generated by atomizing an e-liquid matrix by the atomization assembly.

At least a portion of the body surrounds the accommodating cavity and/or the aerosol conveying channel, and at least one first opening for communicating the accommodating cavity with the aerosol conveying channel is provided in the body. The first opening is located between the first flange and the second flange.

According to the above sealing member, the above atomizer, and the above electronic atomization device, by communicating the accommodating cavity with the aerosol conveying channel through the opening in the side wall of the sealing member, a structural design in the atomizer is simplified, and the costs of the atomizer are reduced.

### BRIEF DESCRIPTION OF THE DRAWINGS

One or more embodiments are exemplarily described with reference to the corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a schematic diagram of an electronic atomization device according to an implementation of the present application.

FIG. 2 is a schematic diagram of an atomizer according to an implementation of the present application.

FIG. 3 is a schematic exploded view of an atomizer according to an implementation of the present application.

FIG. 4 is a schematic cross-sectional view of an atomizer according to an implementation of the present application.

FIG. 5 is another schematic cross-sectional view of an atomizer according to an implementation of the present application.

FIG. 6 is a schematic diagram of an atomization assembly according to an implementation of the present application.

FIG. 7 is a schematic diagram of an atomization assembly according to an implementation of the present application, viewed in another angle.

FIG. 8 is a schematic diagram of another atomization assembly according to an implementation of the present application.

FIG. 9 is a schematic diagram of another atomization assembly according to an implementation of the present application, viewed in another angle.

FIG. 10 is a schematic diagram of a sealing member according to an implementation of the present application.

FIG. 11 is a schematic cross-sectional view of a sealing member according to an implementation of the present application.

FIG. 12 is a schematic cross-sectional view of a sealing member according to an implementation of the present application, viewed in another angle.

FIG. 13 is a schematic diagram of a sealing member and an atomization assembly which are combined according to an implementation of the present application.

FIG. 14 is a schematic diagram of a bottom cover according to an implementation of the present application.

FIG. 15 is a schematic diagram of another electrode according to an implementation of the present application.

### DETAILED DESCRIPTION

For ease of understanding of the present application, the present application is described below in more detail with reference to accompanying drawings and specific implementations. It should be noted that, when an element is expressed as “being fixed to” another element, the element may be directly on the another element, or one or more intermediate elements may exist between the element and the another element. When one component is expressed as “being connected to” another component, the component may be directly connected to the another component, or one or more intermediate components may exist between the component and the another component. The terms “upper”, “lower”, “left”, “right”, “inner”, “outer”, and similar expressions used in this specification are only used for an illustrative purpose.

Unless otherwise defined, meanings of all technical and scientific terms used in this specification are the same as those usually understood by a person skilled in the art to which the present application belongs. The terms used in this specification of the present application are merely intended to describe objectives of the specific implementations, and are not intended to limit the present application. A term “and/or” used in this specification includes any or all combinations of one or more related listed items.

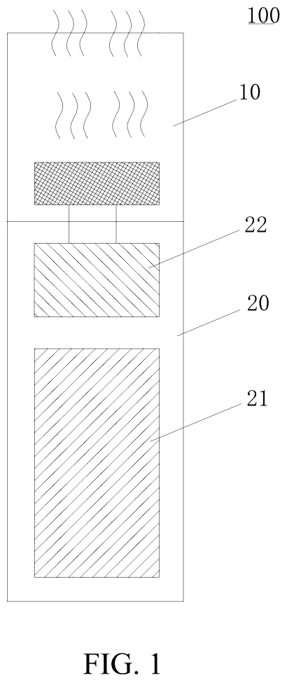

As used herein, terms ‘upstream’ and ‘downstream’ describe relative positions of parts or portions of parts in the electronic atomization device in a direction of flowing of inhaled air. FIG. 1 is a schematic diagram of an electronic atomization device according to an implementation of the present application.

As shown in FIG. 1, an electronic atomization device 100 includes an atomizer 10 and a power supply assembly 20. In some examples, the atomizer 10 and the power supply assembly 20 are non-removable. In some examples, the atomizer 10 is detachably connected to the power supply assembly 20, for example, by interference fit, buckling, or magnetic connection.

The atomizer 10 is configured to heat and atomize an e-liquid matrix to generate an aerosol.

The power supply assembly 20 includes a battery cell 21 and a circuit 22.

The battery cell 21 supplies electric power for operating the electronic atomization device 100. The battery cell 21 may be a rechargeable battery cell or a disposable battery cell.

The circuit 22 may control overall operations of the electronic atomization device 100. The circuit 22 not only controls operations of the battery cell 21 and the atomizer 10, but also controls an operation of another element in the electronic atomization device 100.

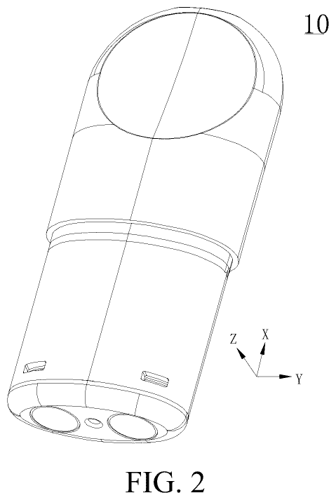

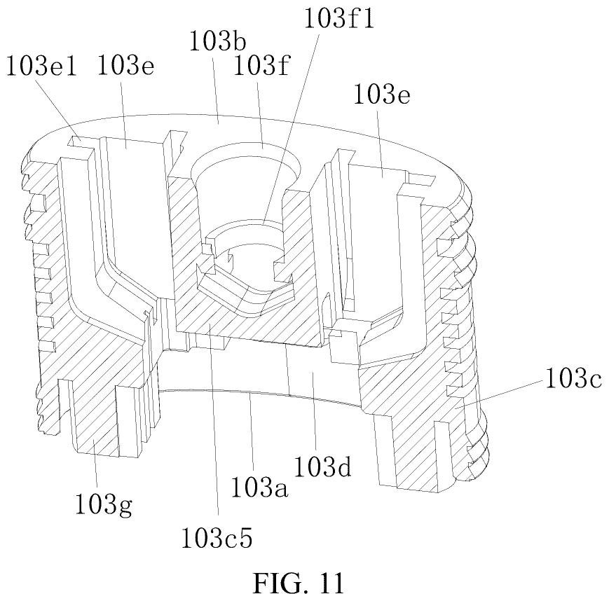

FIG. 2 to FIG. 14 show schematic structural diagrams of an atomizer according to an embodiment. The atomizer 10 of this embodiment includes:
a shell 101, a near end of which has an opening 101a and a far end of which has an opening 101b. The opening 101a may be used as an aerosol outlet. A user or a smoker may inhale, through the opening 101a, the aerosol generated by the electronic atomization device 100. An aerosol conveying tube 101c and an e-liquid storage cavity 101d are arranged inside the shell 101. One end of the aerosol conveying tube 101c is communicated with the opening 101a. The e-liquid storage cavity 101d is configured to store an e-liquid matrix. The e-liquid storage cavity 101d is communicated with the opening 101b. The atomization assembly 102 and the sealing member 103 may be assembled into the shell 101 through the opening 101b. In a further implementation, a positioning column (not shown) is further arranged on an inner surface of the shell 101. When the sealing member 103 is assembled into the shell 101 through the opening 101b, an upstream end 103a of the sealing member 103 may be positioned through the positioning column.

In some examples, at least a portion of the shell 101 is made of a transparent material, e.g. transparent plastic, so that internal members and the e-liquid matrix can be observed through the shell 101. For example: An accommodating cavity 103d, the atomization assembly 102, or an aerosol conveying channel 103f are observable through an opening 103c3.

The atomization assembly 102 includes an e-liquid guide element 102a and a heating element 102b.

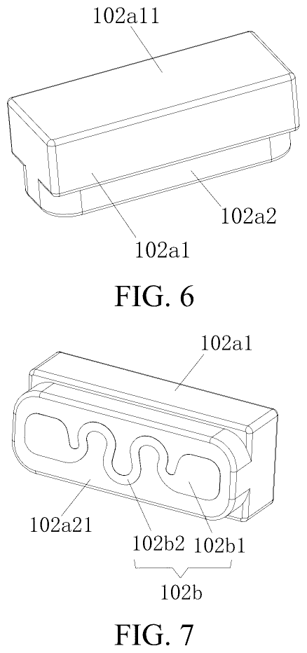

As shown in FIG. 6 to FIG. 7, in an example, the e-liquid guide element 102a is a rigid porous body, preferably, a ceramic porous body. The e-liquid guide element 102a is approximately block-like. The e-liquid guide element 102a includes a first portion 102a1, and a second portion 102a2 axially extending from the first portion 102a1. A size of the first portion 102a1 in a length direction (an X direction in FIG. 2) of the electronic atomization device 100 or the atomizer 10 is slightly greater than a size of the second portion 102a2 in the length direction of the electronic atomization device 100. A size of the first portion 102a1 in a thickness direction (a Z direction in FIG. 2) of the electronic atomization device 100 or the atomizer 10 is slightly greater than a size of the second portion 102a2 in the thickness direction of the electronic atomization device 100. A size of the first portion 102a1 in a width direction (a Y direction in FIG. 2) of the electronic atomization device 100 or the atomizer 10 is the same as a size of the second portion 102a2 in the width direction of the electronic atomization device 100.

A surface 102a11 of the first portion 102a1 defines an e-liquid absorbing surface, and a surface 102a21 of the second portion 102a2 defines an atomization surface. The surface 102a11 and the surface 102a21 are arranged oppositely in the length direction of the electronic atomization device 100. The e-liquid guide element 102a transfers the e-liquid matrix from the e-liquid absorbing surface to the atomization surface through a capillary action. The first portion 102a1 and the second portion 102a2 may have the same or different porosities. In a preferred implementation, a porosity of the first portion 102a1 is greater than a porosity of the second portion 102a2.

The heating element 102b is arranged on or combined on the atomization surface, and the heating element 102b is configured to heat and atomize the e-liquid matrix to generate an Aerosol. The heating element 102b may be in a form of resistance heating, and may be formed on the atomization surface in a manner of mounting, printing, depositing, or the like. The heating element 102b includes an electric connection portion 102b1 and a heating line 102b2. Two electric connection portions 102b1 are included, and the heating line 102b2 is arranged between the two electric connection portions 102b1. The heating line 102b2 may be made of stainless steel, nicochrome, fe—cr—al alloy, metal titanium, and the like. As shown in FIG. 7, the heating line 102b2 is a patterned conductive trajectory, such as a zigzag pattern and a sinuous pattern. The electric connection portion 102b1 may be in a form of a pad, and may be square, circular, elliptical, or the like.

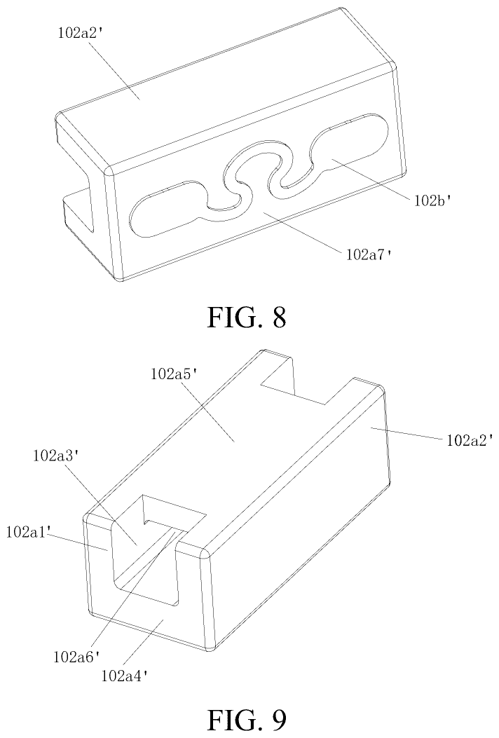

As shown in FIG. 8 to FIG. 9, in another example, the e-liquid guide element 102a entirely has a first side wall 102a1′ and a second side wall 102a2′ which are opposite to each other in the thickness direction, and a notch 102a3′ located between the first side wall 102a1′ and the second side wall 102a2′. The e-liquid guide element 102a further has an atomization surface 102a7′ that faces away from the first side wall 102a1′ and/or the second side wall 102a2′ and/or the notch 102a3′ and/or the e-liquid storage cavity 101d in a longitudinal direction.

The base body portion 102a4′ is located on a lower end side of the e-liquid guide element 102a in the longitudinal direction, and extends between the first side wall 102a1′ and the second side wall 102a2′. In addition, an extension length of the base body portion 102a4′ in the length direction of the e-liquid guide element 102a is the same as an extension length of the first side wall 102a1′ and/or the second side wall 102a2′. As shown in the figure, a lower surface of the base body portion 102a4′ is used as an atomization surface 102a7′.

A connection portion 102a5′ is located at an upper end side of the e-liquid guide element 102a in the longitudinal direction and is arranged close to a central portion of the e-liquid guide element 102a. Similarly, the connection portion 102a5′ extends between the first side wall 102a1′ and the second side wall 102a2′. Furthermore, an extension length of the connection portion 102a5′ in the length direction of the e-liquid guide element 102a is less than an extension length of the first side wall 102a1′ and/or the second side wall 102a2′ and/or the base body portion 102a4′. Thus, a notch 102a3′ is formed by a region that is not covered by the connection portion 102a5′.

In addition, a space 102a6′ extending in the length direction is defined between the connection portion 102a5′ and the base body portion 102a4′. The space 102a6′ may be configured to receive or buffer the e-liquid matrix, so as to adjust an amount or efficiency of the e-liquid matrix supplied to the atomization surface 102a7′.

The heating element 102b′ is arranged on the atomization surface 102a7′ of the e-liquid guide element 102a to form an atomization assembly, so as to heat and mist at least a portion of the e-liquid matrix in the e-liquid guide element 102a to generate an aerosol, and the aerosol is released by the atomization surface 102a7′.

For ease of description, the following is described by using the atomization assembly 102 shown in FIG. 6 to FIG. 7 for explanation.

The sealing member 103 is made of a flexible material. The sealing member 103 may be made of a flexible material such as silica gel, a thermoplastic elastomer, or thermoplastic rubber. Preferably, the sealing member 103 is made of a single material such as the thermoplastic elastomer.

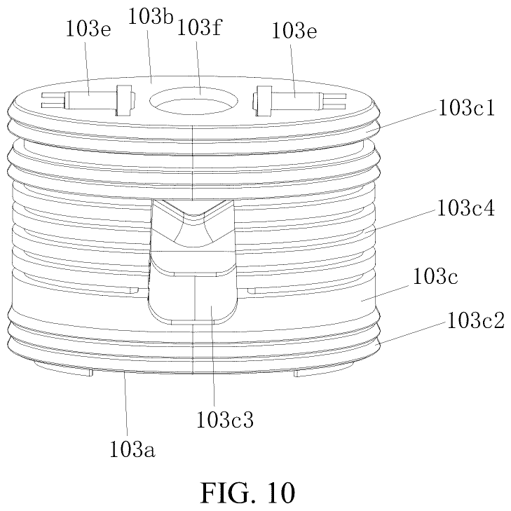

As shown in FIG. 10 to FIG. 12, the sealing member 103 includes an upstream end 103a (an end far away from the e-liquid storage cavity 101d), a downstream end 103b (an end close to the e-liquid storage cavity 101d), a body 103c extending from the upstream end 103a to the downstream end 103b, an accommodating cavity 103d, an e-liquid conveying channel 103e, an aerosol conveying channel 103f, and a protruding arm 103g.

An end surface of the upstream end 103a has an opening.

The end surface of the downstream end 103b has an opening communicated with the e-liquid conveying channel 103e. The opening is used as an e-liquid inlet, and the e-liquid matrix stored in the e-liquid storage cavity 101d can flow into the e-liquid conveying channel 103e through the opening. The end surface of the downstream end 103b further has an opening communicated with the aerosol conveying channel 103f.

At least one flange 103cl is arranged on an outer surface of the body 103c close to the upstream end 103a, and at least one flange 103c2 is arranged on an outer surface of the body 103c close to the downstream end 103b. The flange 103cl and the flange 103c2 are both arranged around a periphery of the body 103c, to form a convex ring. A quantity of the flange 103c1 is not limited, and a plurality of flanges 103c1 spaced apart may be arranged on the outer surface of the body 103c. The flange 103c2 is similar to the flange 103c1. The flange 103c1 and the flange 103c2 both keep in contact with the inner surface of the shell 101, to achieve sealing. In a preferred implementation, four flanges 103c1 are arranged on the outer surface of the body 103c close to the upstream end 103a. The four flanges 103c1 are arranged in sequence in the length direction of the electronic atomization device 100 or the atomizer 10. Two flanges 103c1 are arranged next to the upstream end 103a, and the other two flanges 103c1 keep a spacing away from the two flanges 103c1. Two to four flanges 103c2 are arranged on the outer surface of the body 103c close to the downstream end 103b. The flanges 103c2 are arranged in the length direction of the electronic atomization device 100 or the atomizer 10 in sequence. The flanges 103c2 are arranged next to the downstream end 103b.

An opening 103c3 is provided in at least one of two opposite side walls of the body 103c in the thickness direction of the electronic atomization device 100 or the atomizer 10. The opening 103c3 is arranged between the flanges 103c1 and the flanges 103c2 in the length direction of the electronic atomization device 100 or the atomizer 10. The opening 103c3 penetrates through the inner surface and outer surfaces of the body 103c, and is communicated with the accommodating cavity 103d and the aerosol conveying channel 103f. A size of the opening 103c3 in the length direction of the electronic atomization device 100 or the atomizer 10 is between 5 mm and 7 mm. In a preferred implementation, the size is between 5 mm and 6 mm. In a further preferred implementation, the size is between 5.5 mm and 6 mm. A size of the opening 103c3 in the width direction of the electronic atomization device 100 or the atomizer 10 is between 3 mm and 5 mm. In a preferred implementation, the size is between 3 mm and 4.5 mm. In a further preferred implementation, the size is between 3.5 mm and 4.5 mm.

An e-liquid holding region for holding a portion of the e-liquid matrix from the accommodating cavity 103d or the aerosol conveying channel 103f is defined between the body 103c, located between the flanges 103cl and the flanges 103c2, and the shell 101. The e-liquid holding region includes a plurality of capillary grooves 103c4 distributed on an outer surface of the body 103c, and the capillary grooves 103c4 at least partially extend along the periphery of the body 103c. In a preferred implementation, one end of each capillary groove 103c4 is communicated with the opening 103c3, and the other end of each capillary groove 103c4 extends along the periphery of the body 103c to the opening 103c3. A quantity of the capillary grooves 103c4 is not limited. A plurality of capillary grooves 103c4 spaced apart may be provided in the outer surface of the body 103c, and the plurality of capillary grooves 103c4 spaced apart may be communicated with each other (for example, capillary grooves extending in the length direction of the electronic atomization device 100 or the atomizer 10 are provided in the outer surface of the body 103c, to communicate the plurality of capillary grooves 103c4 spaced apart). In a preferred implementation, approximately five to six capillary grooves 103c4 are arranged in the length direction of the electronic atomization device 100 or the atomizer 10 in sequence. The capillary grooves 103c4 are spaced apart, without communication. A size of each capillary groove 103c4 in the length direction of the electronic atomization device 100 or the atomizer 10 is between 0.4 mm and 0.6 mm, and a spacing distance between adjacent capillary grooves 103c4 is between 0.4 mm and 0.6 mm. A spacing distance between the capillary grooves 103c4 and the flanges 103c1 should be less than a spacing distance between the capillary grooves 103c4 and the flanges 103c2. In this way, it is convenient to store the e-liquid matrix or condense e-liquid between the capillary grooves 103c4 and the flanges 103c2.

A separation wall 103c5 is further arranged in the body 103c. The accommodating cavity 103d is spaced apart from the aerosol conveying channel 103f in the length direction of the electronic atomization device 100 or the atomizer 10 through the separation wall 103c5. A side of the separation wall 103c5 that faces the aerosol conveying channel 103f has an approximately V-shaped surface, which is conductive to collecting the condense e-liquid in the aerosol conveying channel 103f and guiding the e-liquid to the accommodating cavity 103d, so that the e-liquid guide element 102a absorbs the e-liquid again.

The accommodating cavity 103d is arranged in the body 103c. The accommodating cavity 103d is communicated with the opening of the upstream end 103a, and the atomization assembly 102 may be assembled into the accommodating cavity 103d through the opening of the upstream end 103a. An e-liquid absorbing surface of the atomization assembly 102 faces the e-liquid storage cavity 101d, and an atomization surface of the atomization assembly 102 faces the opening of the upstream end 103a. At least a portion of a space between the atomization surface and the opening of the upstream end 103a forms an atomization chamber A. When the atomization assembly 102 is assembled to the accommodating cavity 103d through the opening of the upstream end 103a, a local boundary of the atomization chamber A or a local boundary of the aerosol conveying channel 103f is defined by the inner surface of the shell 101. In this way, the boundary of the atomization chamber A or the boundary of the aerosol conveying channel 103f is obviously enlarged, which helps to reduce generation of condense e-liquid.

Two outer surfaces (left and right side walls), which are opposite to each other in the width direction of the electronic atomization device 100, of the e-liquid guide element 102a are in contact with or elastically abutted to a portion of an inner surface 103c6 of the body 103c, and two outer surfaces (front and rear side walls), which are opposite in the thickness direction of the electronic atomization device 100, of the first portion 102a1 of the e-liquid guide element 102a are partially in contact with or elastically abutted to a portion of an inner surface 103c7 of the body 103c. Therefore, at least a portion of an outer surface of the e-liquid guide element 102a is sealed.

In some embodiments, two outer surfaces (left and right outer surfaces), which are opposite to each other in the width direction of the electronic atomization device 100 or the atomizer 10, of the e-liquid guide element 102a are in contact with or elastically abutted to portions of two inner surfaces 103c6, which are opposite to each other in the width direction of the electronic atomization device 100 or the atomizer 10, of the body 103c in a one-to-one correspondence manner. The one-to-one correspondence means that a left side wall of the e-liquid guide element 102a keeps in contact with or elastically abutted to a portion of the inner surface 103c6 on a left side of the body 103c, and a right side wall of the e-liquid guide element 102a keeps in contact with or elastically abutted to a portion of the inner surface 103c6 on a right side of the body 103c. Two outer surfaces (front and rear side surfaces), which are opposite to each other in the thickness direction of the electronic atomization device 100 or the atomizer 10, of the first portion 102a1 of the e-liquid guide element 102a are partially in contact with or elastically abutted to portions of two inner surfaces 103c7, opposite to each other in the thickness direction of the electronic atomization device 100 or the atomizer 10, of the body 103c in a one-to-one correspondence manner. Therefore, at least a portion of an outer surface of the e-liquid guide element 102a is sealed. The portions of the inner surfaces 103c6 and the portions of the inner surfaces 103c7 both define the local boundary of the accommodating cavity 103d.

In a further implementation, a size of the e-liquid guide element 102a in the width direction of the electronic atomization device 100 or the atomizer 10 should be slightly greater than a distance between the portions of the two inner surfaces 103c6 of the body 103c (or a size of the accommodating cavity 103d in the width direction of the electronic atomization device 100 or the atomizer 10), and a size of the first portion 102a1 in the thickness direction of the electronic atomization device 100 or the atomizer 10 should be slightly greater than the distance between the portions of the two inner surfaces 103c7 of the body 103c (or a size of the accommodating cavity 103d in the thickness direction of the electronic atomization device 100 or the atomizer 10). Thus, the sealing member 103 is in better interference fit with the e-liquid guide element 102a.

The e-liquid absorbing surface of the atomization assembly 102 and a surface 103c51 of the separation wall 103c5 that faces the e-liquid absorbing surface may be kept in contact with or elastically abutted to each other in the length direction of the electronic atomization device 100 or the atomizer 10. The surface 103c51 of the separation wall 103c5 is further provided with a groove 103c52, and the groove 103c52 extends in the width direction of the electronic atomization device 100 or the atomizer 10.

It should be noted that, in another example, it is also feasible that the e-liquid absorbing surface of the atomization assembly 102 may not be in contact with the surface 103c51 of the separation wall 103c5 in the length direction of the electronic atomization device 100 or the atomizer 10.

It should be noted that, for the atomization assembly 102 exemplified in FIG. 8 to FIG. 9, the separation wall 103c5 is not provided. It is feasible that an end surface of a lower end of the aerosol conveying channel 103f keeps in contact with or elastically abutted to the connection portion 102a5′.

Two outer surfaces, which are opposite to each other in the thickness direction of the electronic atomization device 100, of the second portion 102a2 of the e-liquid guide element 102a are spaced apart from the inner surfaces of the body 103c. In this way, a heat loss of the heating element 102b can be avoided.

In some embodiments, two outer surfaces (front and rear side surfaces), which are opposite to each other in the thickness direction of the electronic atomization device 100 or the atomizer 10, of the e-liquid guide element 102a are spaced apart from portions of two inner surfaces 103c8, which are opposite to each other in the thickness direction of the electronic atomization device 100 or the atomizer 10, of the body 103c in a one-to-one correspondence manner. The portions of the inner surfaces 103c8 define the local boundary of the accommodating cavity 103d. Since the heating element 102b is arranged on the second portion 102a2, a temperature of the second portion 102a2 is excessively high (the temperature is higher if the second portion 102a2 is closer to the atomization surface). The second portion 102a2 of the e-liquid guide element 102a and the portions of the two inner surfaces 103c8 of the body 103c are spaced apart in the one-to-one correspondence manner, so that on the one hand, a problem that excessive heat is conducted to the sealing member 103, and as a result, the sealing member 103 is prone to deformation can be avoided, and on the other hand, the heat loss of the heating element 102b can be reduced.

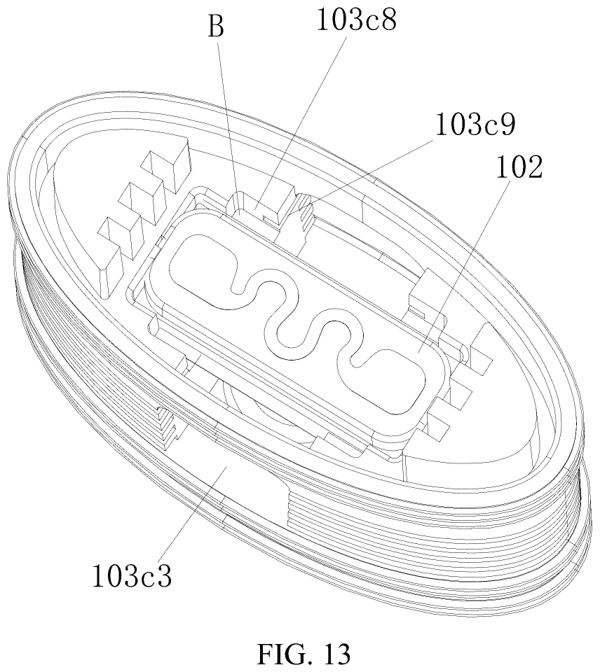

In some optional embodiments, as shown in FIG. 13, when the e-liquid guide element 102a is accommodated in the accommodating cavity 103d, since the two outer surfaces (the front and rear side surfaces) of the e-liquid guide element 102a are spaced apart from the portions of the two inner surfaces 103c8 of the body 103c in the one-to-one correspondence manner, a plurality of grooves B for storing a portion of the e-liquid matrix are formed between the outer surfaces of the e-liquid guide element 102a and the inner surfaces 103c8 of the body 103c. The grooves B are sunken towards the e-liquid storage cavity 101d, and approach the surface 103c51 of the separation wall 103c5. The grooves B are adjacent to the atomization surface of the e-liquid guide element 102a. For example, referring to FIG. 13, four grooves B are formed, which are distributed at four corner positions close to the atomization surface of the e-liquid guide element 102a. The grooves B are not directly communicated with the e-liquid storage cavity 101d, and are isolated through the e-liquid guide element 102a. A width size (a size in the thickness direction of the electronic atomization device 100 or the atomizer 10) of each groove B is between 0.4 mm and 0.6 mm. In a specific example, the width size may be 0.45 mm, 0.5 mm, 0.55 mm, or the like. A length size (a size in the width direction of the electronic atomization device 100 or the atomizer 10) of each groove B is between 0.8 mm and 1.5 mm. In a specific example, the length size may be 1 mm, 1.2 mm, 1.4 mm, or the like. A depth size (a size in the length direction of the electronic atomization device 100 or the atomizer 10) of each groove B is between 1 mm and 2 mm. In a specific example, the depth size may be 1.2 mm, 1.4 mm, 1.6 mm, 1.8 mm, or the like. The foregoing grooves B may be configured to store the e-liquid matrix or the condense e-liquid that seeps out of the e-liquid guide element 102a, thereby effectively enhancing an e-liquid leakage effect and a vaping experience. When the atomization assembly 102 starts heating, the e-liquid matrix or the condense e-liquid stored in the grooves B may be drawn up by the e-liquid guide element 102a and is heated and atomized by the heating element 102b. The grooves B are adjacent to the atomization surface of the e-liquid guide element 102a, which helps to more rapidly replenish the heating element 102b with the e-liquid matrix. Further, when the e-liquid matrix or condense e-liquid stored in the grooves B is excessive, the e-liquid matrix or condense e-liquid may be guided to a collection cavity 104d of a bottom cover 104 through a guide slot 103g1.

In a further implementation, the grooves B may be communicated with the capillary grooves 103c4. For example, the grooves B and the capillary grooves 103c4 are communicated through capillary grooves 103c9 formed in the opening 103c3. The capillary grooves 103c9 formed in the opening 103c3 extend approximately in the thickness direction of the electronic atomization device 100 or the atomizer 10. One end of each capillary groove is in fluid communication with each groove B, and the other end is in fluid communication with each capillary groove 103c4. In this way, an e-liquid matrix or condense e-liquid stored in the capillary grooves 103c4 can flow into the grooves B along the capillary grooves 103c9 formed in the opening 103c3.

The e-liquid conveying channel 103e is arranged in the body 103c. One end of the e-liquid conveying channel 103e is communicated with the opening of the end surface of the downstream end 103b, and the other end is communicated with the accommodating cavity 103d. In a preferred implementation, two e-liquid conveying channels 103e are symmetrically arranged in the body 103c in the width direction of the electronic atomization device 100 or the atomizer 10, and the two e-liquid conveying channels 103e may be communicated through the groove 103c52 of the separation wall 103c5. In this way, a contact area between the e-liquid matrix and the e-liquid guide element 102a is larger, and the e-liquid matrix can be more smoothly guided to the e-liquid guide element 102a.

The aerosol conveying channel 103f is arranged in the body 103c. One end of the aerosol conveying channel 103f is communicated with the opening of the end surface of the downstream end 103b, and the other end is communicated with the accommodating cavity 103d through the opening 103c3. The aerosol conveying channel 103f is configured to convey the aerosol generated by atomization by the atomization assembly 102.

After assembling, the other end of the aerosol conveying tube 101c is inserted into the aerosol conveying channel 103f through the opening of the end surface of the downstream end 103b, so that the sealing member 103 seals the aerosol conveying tube 101c.

In a further implementation, a stop portion 103f1 is further arranged inside the aerosol conveying channel 103f, to stop the other end of the aerosol conveying tube 101c. The stop portion 103f1 includes a convex block arranged on an inner surface of the aerosol conveying channel 103f.

In a further implementation, the stop portion 103f1 is further provided with a guide slot 103f11. Through the guide slot 103f11, the condense e-liquid in the aerosol conveying tube 101c can be better guided to the atomization assembly 102, but not accumulated on the separation wall 103c5.

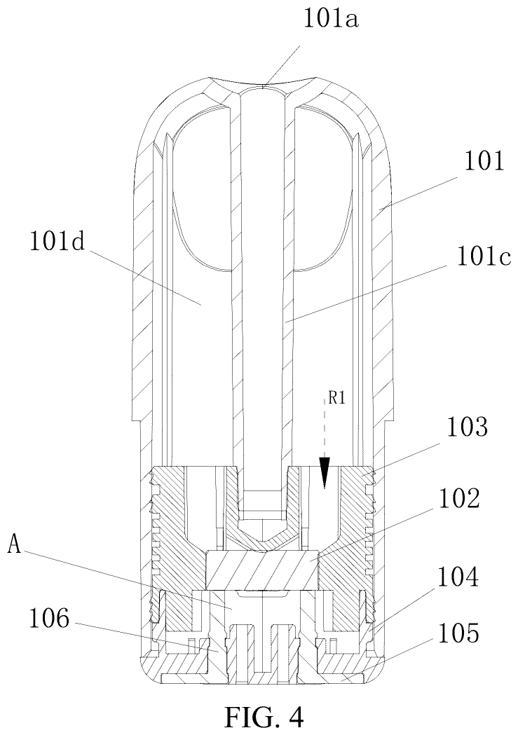

The e-liquid storage cavity 101d is defined and formed by the inner surface of the shell 101, an outer surface of the aerosol conveying tube 101c, and the end surface of the downstream end 103b of the sealing member 103. The e-liquid matrix stored in the e-liquid storage cavity 101d may be conveyed to the atomization assembly 102 (as shown by R1 in FIG. 4) through the e-liquid conveying channel 103e.

In a further implementation, a capillary groove 103el is provided in the e-liquid conveying channel 103e. One end of the capillary groove 103e1 is communicated with the opening of the end surface of the downstream end 103b, and the other end extends to a portion of an inner surface 103c6 of the body 103c, so as to be communicated with the accommodating cavity 103d. The capillary groove 103e1 is conductive to guiding an air mass or air bubbles from the outside or the atomization chamber A into the e-liquid storage cavity 101d, so that the e-liquid matrix can smoothly pass through the e-liquid conveying channel 103e. A width of the capillary groove 103e1 is between 0.4 mm and 0.6 mm. A quantity of the capillary groove 103e1 is not limited. In a preferred implementation, three to six capillary grooves 103e1 are provided in the e-liquid conveying channel 103e, and the capillary grooves 103e1 are spaced apart.

The protruding arm 103g extends from an inner surface of the body 103c towards the opening of the upstream end 103a.

The bottom cover 104 is detachably bonded to the opening 101b in the far end of the shell 101, so as to define, together with the shell 101, a housing of the atomizer. In a preferred implementation, the bottom cover 104 is in a snapping connection with the shell 101.

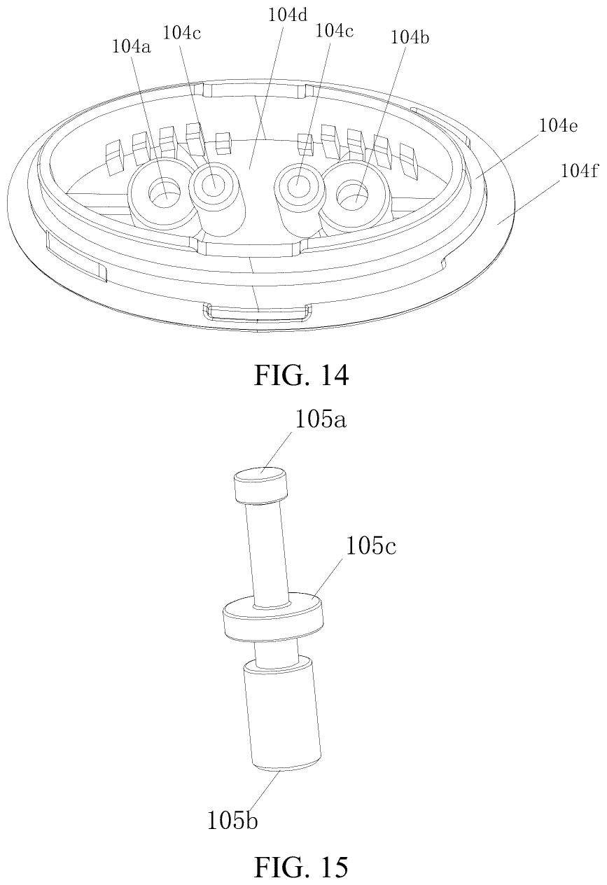

As shown in FIG. 14, a first electrode hole 104a and a second electrode hole 104b are provided in the bottom cover 104, and a first electrode 105 and a second electrode 106 are mounted in a one-to-one correspondence manner. One end of the first electrode 105 keeps in contact with one electric connection portion 102b1 of the heating element 102b to form an electric connection, and the other end of the first electrode 105 is exposed out of the bottom cover 104. One end of the second electrode 106 keeps in contact with the other electric connection portion 102b1 of the heating element 102b to form an electric connection, and the other end of the second electrode 106 is exposed out of the bottom cover 104. Further, the first electrode 105 and the second electrode 106 may further support the atomization assembly 102, so that the atomization assembly 102 is kept in the sealing member 103.

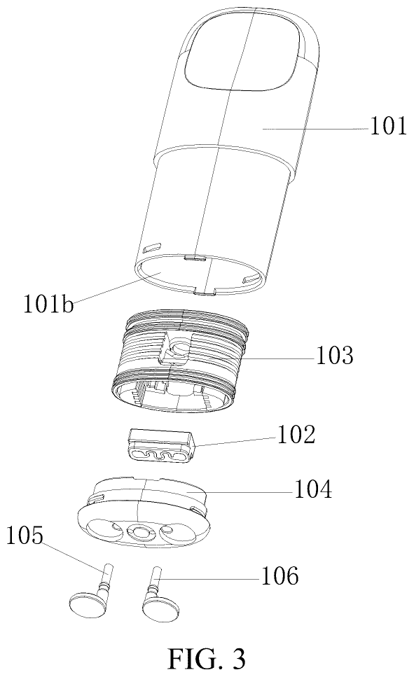

In the example in FIG. 3 to FIG. 7, the first electrode 105 and the second electrode 106 are both non-elastic electrodes. When the first electrode 105 and the second electrode 106 are assembled to the atomizer 10, the first electrode 105 and the second electrode 106 are supported on the bottom cover 104 and linearly extend toward the atomization assembly 102. Since the e-liquid absorbing surface of the atomization assembly 102 keeps in contact with or elastically abutted to the surface 103c51 of the separation wall 103c5, and the sealing member 103 is elastically compressed. Then, an elastic force in a downward direction or a direction opposite to an assembling direction can be provided for the first electrode 105 or the second electrode 106 through the atomization assembly 102, so that one end of the first electrode 105 or the second electrode 106 keeps in good contact with the electric connection portion 102b1 of the heating element 102b and is not easily displaced.

In an alternative embodiment, the first electrode 105 or the second electrode 106 may be replaced with an electrode shown in FIG. 15. As shown in FIG. 15, the electrode includes a first end 105a, a second end 105b opposite to the first end 105a, and a flange 105c arranged between the first end 105a and the second end 105b. An end surface of the first end 105a keeps in contact with the electric connection portion 102b1 of the heating element 102b to form an electric connection, and an end surface of the second end 105b is exposed out of the bottom cover 104. During assembling, the first electrode hole 104a or the second electrode hole 104b stops the flange 105c.

A cross section of a portion of the electrode located between the first end 105a and the flange 105c is small and long. A cross section of a portion of the electrode located between the flange 105c and the second end 105b is large and long. In this way, heat of the heating element 102b from the first end 105a to the second end 105b can be reduced.

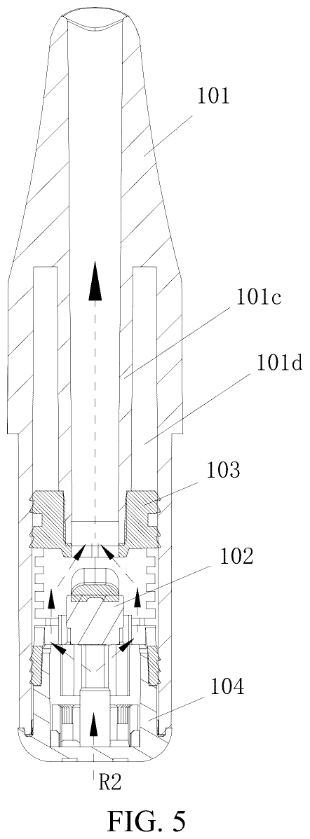

The bottom cover 104 is further provided with an air intake vent 104c. Referring to FIG. 5 again, external air enters the atomizer 10 through the air intake vent 104c. After the aerosol generated by heating and atomizing the e-liquid matrix by the heating element 102b is mixed with the air, the mixture is gathered at the aerosol conveying channel 103f through the opening 103c3, and then flows out from the opening 101a through the aerosol conveying tube 101c (see R2 in the figure). It can be seen from the figure that the opening 103c3 is arranged between the flange 103c1 and the flange 103c2, and both the flange 103c1 and the flange 103c2 keep in contact with the inner surface of the shell 101 to achieve sealing. In this way, it can be ensured that an air flow flows into the aerosol conveying channel 103f through the opening 103c3.

The bottom cover 104 is further provided with the collection cavity 104d. The first electrode hole 104a, the second electrode hole 104b, and the air intake vent 104c all protrude out of the collection cavity 104d. The collection cavity 104d is configured to collect the e-liquid matrix, so as to avoid the e-liquid matrix from flowing to the power supply assembly 20.

A step 104e and a step 104f are provided on an outer surface of the bottom cover 104. After assembling, a portion of a side wall of the bottom cover 104 is sandwiched between the protruding arm 103g of the sealing member 103 and the inner surface of the shell 101. The end surface of the upstream end 103a is abutted to the step 104e; and an end surface of the far end of the shell 101 is abutted to the step 104f. In a further implementation, the protruding arm 103g is further provided with a guide slot 103g1. The guide slot 103g1 is configured to better guide the e-liquid matrix or condense e-liquid to the collection cavity 104d of the bottom cover 104, to avoid the e-liquid matrix from flowing to the power supply assembly 20.

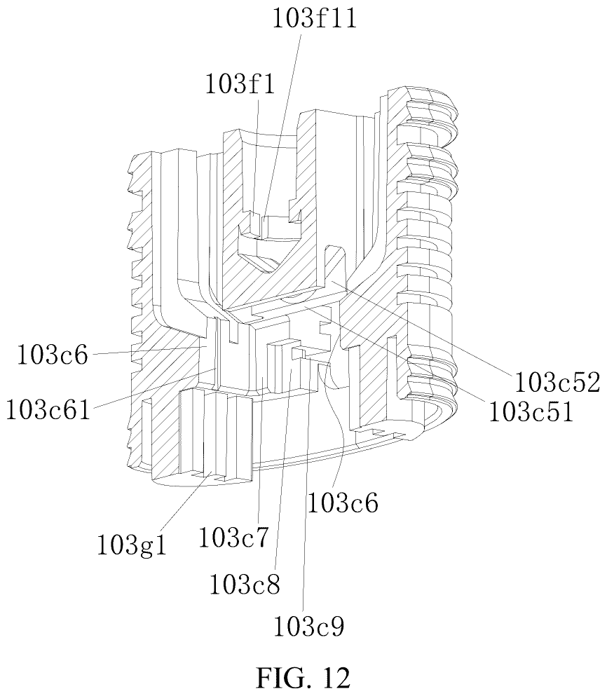

Further, referring to FIG. 12, an air flow slot 103c61 is provided in a portion of an inner surface 103c6 of the body 103c. The air flow slot 103c61 extends on the inner surface 103c6 of the body 103c to the e-liquid conveying channel 103e. The air flow slot 103c61 defines and forms an air pressure balance channel. One end of the air flow slot 103c61 is communicated with the atomization chamber A, and the other end is communicated with the e-liquid conveying channel 103e. Due to the existence of the air flow slot 103c61, when the atomization assembly 102 may be assembled into the accommodating cavity 103d through the opening of the upstream end 103a, a small gap exists between the atomization assembly 102 and the portion of the inner surface 103c6 of the body 103c, and the air entering the atomization chamber A may flow into the e-liquid storage cavity 101d through the air flow slot 103c61, thereby relieving a negative pressure in the e-liquid storage cavity 101d.

In some examples, the air pressure balance channel may be defined and formed by an air flow slot arranged on a portion of an inner surface 103c7 of the body 103c.

In some examples, the air flow slot may be arranged on two outer surfaces (or one outer surface is also feasible), which are opposite to each other in the width or thickness direction of the electronic atomization device 100 or the atomizer 10, of the e-liquid guide element 102a.

In some examples, the air pressure balance channel may be defined and formed by a via hole (not shown) that is provided in the separation wall 103c5. One end of the via hole is communicated with the aerosol conveying channel 103f, and the other end is communicated with the e-liquid conveying channel 103e or the groove 103c52 of the separation wall 103c5.

It should be noted that, the specification of the present application and the accompanying drawings thereof illustrate preferred embodiments of the present application. However, the present application may be implemented in different forms, and is not limited to the embodiments described in this specification. These embodiments are not intended to be an additional limitation on the content of the present application, and are provided for the purpose of providing a more thorough and comprehensive understanding of the content disclosed in the present application. Moreover, the foregoing technical features are further combined to form various embodiments not listed above, and all such embodiments shall be construed as falling within the scope of the present application. Further, a person of ordinary skill in the art may make improvements or transformations according to the foregoing description, and all the improvements and transformations shall fall within the protection scope of the appended claims of the present application.

1. An atomizer, comprising a housing, wherein the housing is provided inside with:
an e-liquid storage cavity, configured to store an e-liquid matrix;
an atomization assembly, configured to atomize the e-liquid matrix to generate an aerosol; and
a sealing member, partially defining the e-liquid storage cavity; an accommodating cavity and an aerosol conveying channel are provided in the sealing member; the accommodating cavity is configured to accommodate the atomization assembly, and the aerosol conveying channel is configured to convey the aerosol generated by atomizing the e-liquid matrix by the atomization assembly,
wherein the sealing member comprises a side wall that at least partially surrounds the accommodating cavity and/or the aerosol conveying channel; and the side wall has at least one first opening that communicates the accommodating cavity with the aerosol conveying channel, so that the aerosol generated by the atomization assembly flows into the aerosol conveying channel through the first opening.

2. (canceled)

3. The atomizer according to claim 1, wherein the sealing member comprises an upstream end far away from the e-liquid storage cavity, a downstream end close to the e-liquid storage cavity, and a body extending from the upstream end to the downstream end;
an outer surface of the body close to the upstream end has a first flange; an outer surface of the body close to the downstream end has a second flange; and the first flange and the second flange keep in contact with an inner surface of the housing to achieve sealing.

4. The atomizer according to claim 3, wherein the first opening is arranged between the first flange and the second flange.

5. The atomizer according to claim 3, wherein an e-liquid holding region is defined between a portion of the body that is located between the first flange and the second flange and the housing, and the e-liquid holding region is configured to hold a portion of the e-liquid matrix from the accommodating cavity or the aerosol conveying channel.

6. The atomizer according to claim 5, wherein the e-liquid holding region comprises a plurality of first capillary grooves distributed on the outer surface of the body, and the first capillary grooves are communicated with the first opening.

7. The atomizer according to claim 1, wherein one end of the sealing member far away from the e-liquid storage cavity has a second opening communicated with the accommodating cavity, and the atomization assembly is accommodated in the accommodating cavity through the second opening.

8. The atomizer according to claim 1, wherein the atomization assembly comprises an e-liquid guide element and a heating element bound to the e-liquid guide element; the sealing member defines that a portion of an inner surface of the accommodating cavity is elastically abutted to at least a portion of an outer surface of the e-liquid guide element, to seal the portion of the outer surface of the e-liquid guide element.

9. The atomizer according to claim 8, wherein a gap is maintained between at least one outer surface of the e-liquid guide element and a part of the inner surface of the accommodating cavity, so that a groove for storing a portion of the e-liquid matrix is formed between the at least one outer surface of the e-liquid guide element and the part of the inner surface of the accommodating cavity.

10. The atomizer according to claim 1, wherein an e-liquid conveying channel communicated with the accommodating cavity is further arranged in the sealing member, and the e-liquid conveying channel forms a third opening at one end of the sealing member close to the e-liquid storage cavity.

11. The atomizer according to claim 10, wherein a second capillary groove is provided in an inner surface of the e-liquid conveying channel, and the second capillary groove extends from the third opening to the accommodating cavity.

12. The atomizer according to claim 1, wherein a near end of the housing has a fourth opening that is used as an aerosol outlet, and an aerosol conveying tube is further arranged inside the housing;
one end of the sealing member close to the e-liquid storage cavity has a fifth opening that is communicated with the aerosol conveying channel;
one end of the aerosol conveying tube is communicated with the fourth opening; and
the other end of the aerosol conveying tube is inserted into the aerosol conveying channel through the fifth opening, to achieve sealing.

13. The atomizer according to claim 12, wherein a stop portion is arranged inside the aerosol conveying channel; and the stop portion is configured to stop the other end of the aerosol conveying tube.

14. The atomizer according to claim 13, wherein the stop portion has a guide slot to guide condense e-liquid in the aerosol conveying tube to the atomization assembly.

15. The atomizer according to claim 1, wherein the sealing member further comprises an air pressure balance channel communicated with the e-liquid storage cavity, and the air pressure balance channel is configured to provide a path for replenishing air into the e-liquid storage cavity.

16. The atomizer according to claim 15, wherein an e-liquid conveying channel communicated with the accommodating cavity is further arranged inside the sealing member, and the air pressure balance channel comprises an air flow slot that extends from an inner surface of the accommodating cavity to the e-liquid conveying channel.

17. The atomizer according to claim 1, wherein the atomization assembly is mounted in the sealing member and defines an atomization chamber together with the sealing member; and when the sealing member is accommodated in the housing, a local boundary of the atomization chamber or a local boundary of the aerosol conveying channel is defined by the housing.

18. The atomizer according to claim 1, wherein at least a portion of the housing is transparent, so that the accommodating cavity, the atomization assembly, or the aerosol conveying channel is observable outside the housing through the first opening.

19. The atomizer according to claim 1, wherein the sealing member further comprises a separation wall; the accommodating cavity and the aerosol conveying channel are spaced apart by the separation wall; and the first opening bypasses the separation wall to communicate the accommodating cavity with the aerosol conveying channel.

20. The atomizer according to claim 19, wherein the sealing member further defines an e-liquid conveying channel that is communicated with the accommodating cavity; a groove is provided in a surface of the separation wall that faces the atomization assembly; and the groove is communicated with the e-liquid conveying channel.

21. An electronic atomization device, comprising a power supply assembly and the atomizer according to claim 1.

22. (canceled)
